(19) United States
(12) Patent Application Publication
(10) Pub. No.: US 2008/0022502 A1
(43) Pub. Date: Jan. 31, 2008

(54) Method for producing a golf club head

(76) Inventor: Wen-Cheng Tseng, Kaohsiung (TW)

Correspondence Address: HERSHKOVITZ & ASSOCIATES, 2845 DUKE STREET, ALEXANDRIA, VA, 22314, US

(21) Appl. No.: 11/715,377

(22) Filed: Mar. 8, 2007

(30) Foreign Application Priority Data
Jul. 26, 2006 (TW) 095127269

(51) Int. Cl. B23P 13/00

(52) U.S. Cl. 29/428; 473/332

(57) ABSTRACT

A method for producing a golf club head has a molding step, an injecting step, a surface finishing step and a sealing step. The molding step has obtaining a base and a striking faceplate and punching a recess formed in a front surface of the base and having an opening receiving the striking faceplate, a window and multiple through holes in the base. The injecting step has blocking the window by a stopper and injecting vibration-absorbing material into the recess. The surface finishing step has removing the stopper when the vibration-absorbing material is foamed and molded and then mounting at least one sealing element to block up the at least one through hole. The sealing step has adhering a transparent panel on the recess to seal the window to obtain a golf club head with vibration-absorbing effect. Users can see the vibration-absorbing material from the transparent panel.

### BACKGROUND OF THE INVENTION

1. Field of Invention

The present invention relates to a method for producing a golf club head, and more particularly to a method for producing a golf club head that people can see vibration-absorbing material filled in the golf club.

2. Description of the Related Art

A golf club head with vibration-absorbing effect has a hollow body. The body has a recess and a striking faceplate. The recess is filled with vibration-absorbing material to allow the golf club has vibration-absorbing effect. The striking faceplate covers the recess to stop the vibration-absorbing material from flow out of the recess. Thus, people will feel comfortable when they hit a golf ball with the golf club head filled with vibration-absorbing material.

The conventional golf club head with vibration-absorbing effect can be produced by two methods. One method, first, is molding the vibration-absorbing material to form a filler. The mold has a dimension larger than a dimension of the recess. Then, mounting the filler in the recess and press-fitting the striking faceplate on recess to cover the recess accomplish the golf club head with vibration-absorbing effect. The other method is punching a feeding hole defined through the recess and soldering the striking faceplate on the recess. Next, filling adhesives into the recess via the feeding hole first and then filling the vibration-absorbing material without any foaming agents into the recess. Finally, heating the adhesives and the vibration-absorbing material to solidify in the recess.

However, the golf club head formed from anyone of the above methods has a limited and insufficient vibration-absorbing effect. Therefore, with reference to FIG. 13, a golf club head with improved vibration-absorbing effect in accordance with the above patent has a body (50). The body (50) has a recess (52) and a striking faceplate (60). The recess (52) has an inner space, an outer edge, an inside annular flange (54) and a feeding hole (59). The inside annular flange (54) is located in the recess (52), is formed on the inner space, is behind the outer edge of the recess (52) and has a top, a looped air channel (542), multiple detents (544) and a through hole (582). The detents (544) communicate with the inner space and the looped air channel (542). The through hole communicates with the looped air channel (542). The feeding hole (59) is defined through the recess (52). The striking faceplate (60) is mounted on the top of the inside annular flange (54) to cover the recess (52).

The method is first soldering the striking faceplate (60) on the top of the inside annular flange (54). Then filling or injecting vibration-absorbing material such as polyurethane (PU), two-liquid foam material or granular or powdery solid material into the inner space of the recess (52) is implemented. The two-liquid foam material comprises adhesives and PU. When the two-liquid foam material is injected in the inner space of the recess (52), the adhesives and PU will react to foam and fill the inner space and adheres to the recess (52). The granular or powdery solid material is injected into the inner space of the recess (52) by injector and then foam and mold in the inner space, so the granular or powdery solid material fills the inner space and adheres to the recess (52). When the vibration-absorbing material is filled or injected into the inner space, air in the inner space of the recess (52) will flow into the looped air channel (542) from the detents (544) and flow along the looped air channel (542) to the through hole. Finally, air can flow out of the recess (52). Therefore, the golf club head will have an improved vibration-absorbing effect.

However, although the recess (52) is full of the vibration-absorbing material, users can not see actually the vibration-absorbing material. Thus, users can not determine whether the vibration-absorbing material in the recess (52) is good or not.

To overcome the shortcomings, the present invention provides a method for producing a golf club head to mitigate or obviate the aforementioned.

### SUMMARY OF THE INVENTION

The primary objective of the present invention is to provide a golf club head, and more particularly to a method for producing a golf club head that people can see vibration-absorbing material filled in the golf club.

To achieve the objective, a method for producing a golf club head in accordance with the present invention has a molding step, an injecting step, a surface finishing step and a sealing step. The molding step has obtaining a base and a striking faceplate and punching a recess, a window and multiple through holes in the base. The recess is formed in a front surface of the base and has an opening. The opening receives the striking faceplate to allow the striking faceplate to seal the opening. The injecting step has blocking the window by a stopper and injecting vibration-absorbing material into the recess. The surface finishing step has removing the stopper when the vibration-absorbing material is foamed and molded to adhere the recess and then mounting at least one sealing element to block up the at least one through hole. The sealing step has adhering a transparent panel on the recess to seal the window to obtain a golf club head with vibration-absorbing effect. Because the window is sealed by the transparent panel, users can see the vibration-absorbing material in the inner space of the recess from the transparent panel and determine the vibration-absorbing material is good or not.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a golf club head of a method for producing a golf club head in accordance with the present invention with at least one through hole defined through a lower surface of a base;

FIG. 2 is an exploded perspective view of the golf club head of the method for producing the golf club head in FIG. 1;

FIG. 3 is an operational exploded perspective view of the golf club head of the method for producing the golf club head in FIG. 1 with a nozzle and an exhausting element;

FIG. 4 is a cross sectional end view of the golf club head of the method for producing the golf club head in FIG. 1 with vibration-absorbing material filling a first inner space of a recess;

FIG. 5 is a perspective view of a golf club head of a method for producing a golf club head in accordance with the present invention with at least one through hole defined through a rear surface of a base;

FIG. 6 is a cross sectional end view of the golf club head of the method for producing the golf club head in FIG. 5 with vibration-absorbing material filled with a first inner space of a recess;

FIG. 7 is a perspective view of the golf club head of the method for producing the golf club head in FIG. 1 with at least one exhausting hole;

FIG. 8 is a cross sectional end view of the golf club head of the method for producing the golf club head in FIG. 7 with vibration-absorbing material filling a first inner space and a second inner space of a recess;

FIG. 9 is a perspective view of the golf club head of the method for producing the golf club head in FIG. 5 with at least one exhausting hole;

FIG. 10 is a cross sectional end view of the golf club head of the method for producing the golf club head in FIG. 9 with vibration-absorbing material filling a first inner space and a second inner space of a recess;

FIG. 11 is a perspective view of a golf club head of a method for producing a golf club head in accordance with the present invention with at least one through hole sealed by a stopper;

FIG. 12 is a flow chart of a golf club head of a method for producing a golf club head in accordance with the present invention; and

FIG. 13 is an exploded perspective view of a golf club head of a conventional method for producing a golf club head in accordance with the prior art.

### DETAILED DESCRIPTION OF THE INVENTION

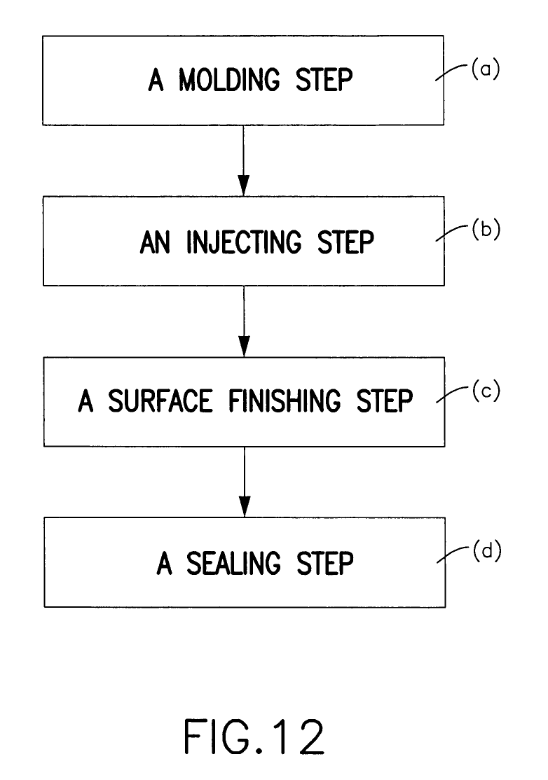

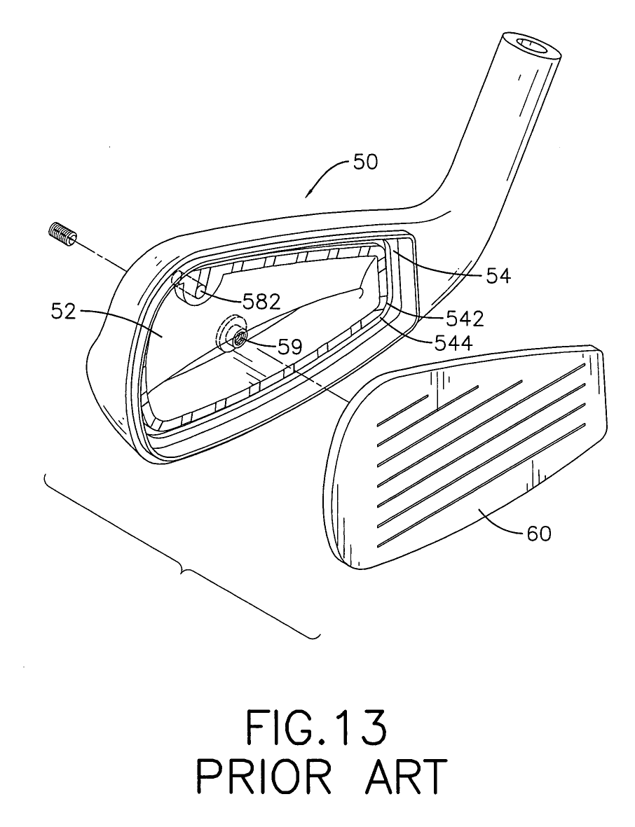

With reference to FIG. 12, a method for producing a golf club head in accordance with the present invention has a molding step (a), an injecting step (b), a surface finishing step (c) and a sealing step (d).

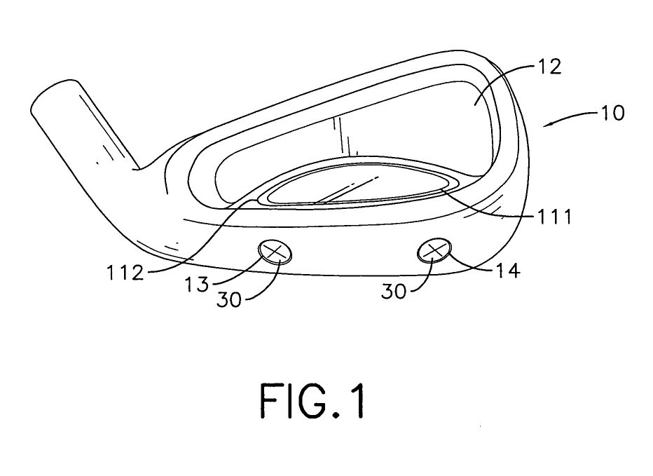

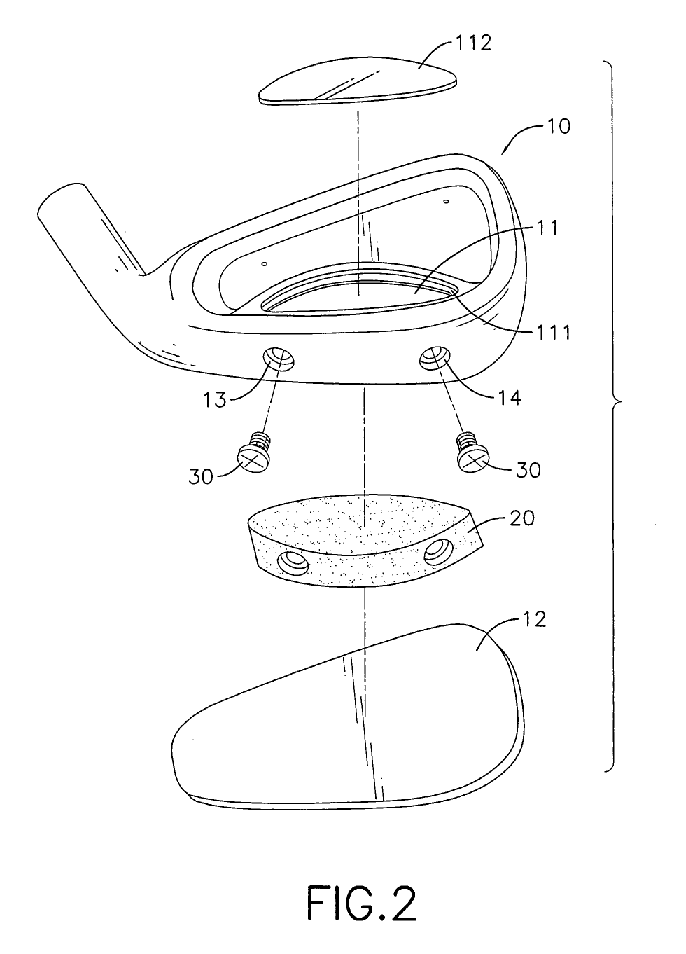

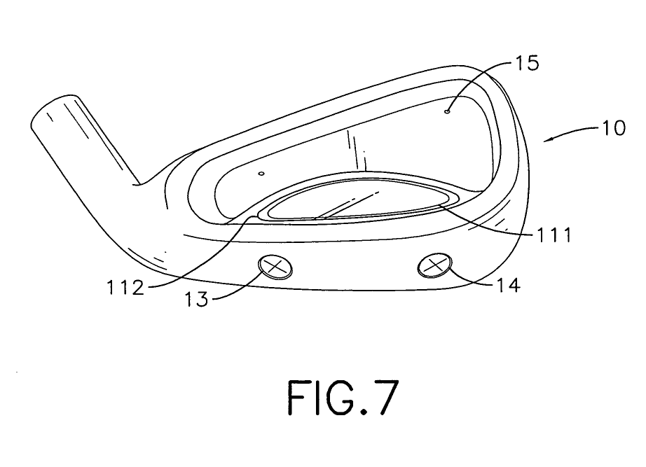

With further reference to FIGS. 1, 2, 5 and 7, the molding step (a) comprises obtaining a base (10) and a striking faceplate (12) and punching a recess (11), an window (11), multiple through holes (13, 13A, 14, 14A) in the base (10) and at least one exhausting hole (15) in the striking faceplate (12). The base (10) has a front surface, a rear surface, an upper surface and a lower surface. The recess (11) is formed in the front surface and has an opening, a first inner space (113) and a second inner space (114). The opening is formed in the front surface of the base (10) and receives the striking faceplate (12) to block up the opening. The window (111) is defined through the rear surface of the base (10) and communicates with the recess (11). The through holes (13, 13A, 14, 14A) are defined through the base (10), communicate with the recess (11) and may be defined through the lower surface of the base (10) or through the rear surface of the base (10). The at least one exhausting hole (15) is defined through the striking faceplate (12) and may be near the upper surface of the base (10).

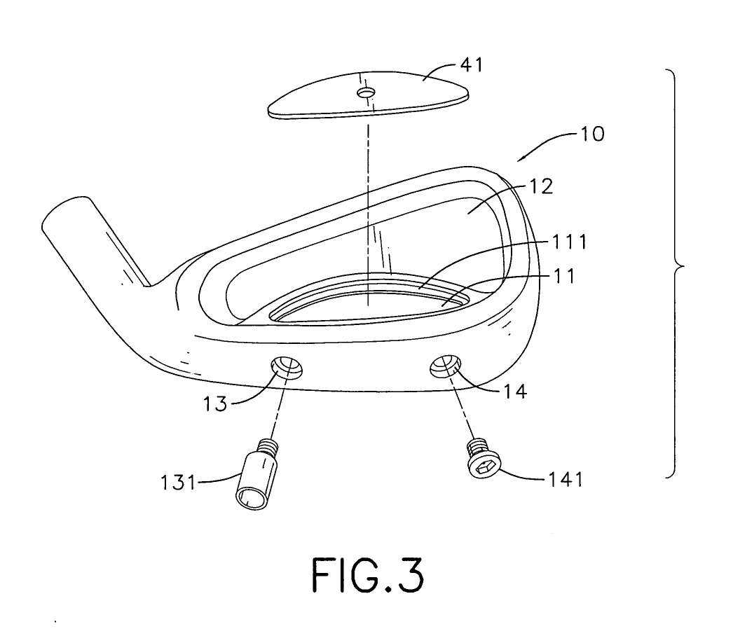

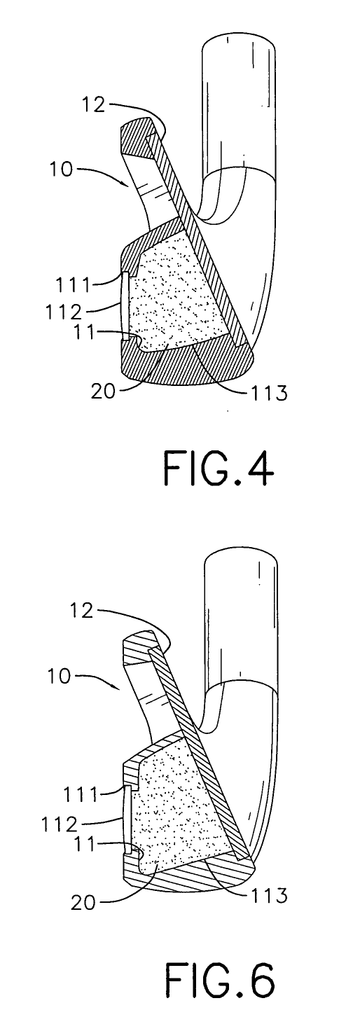

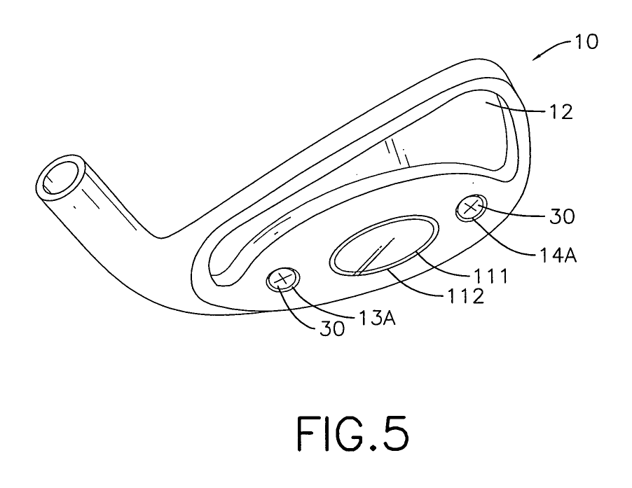

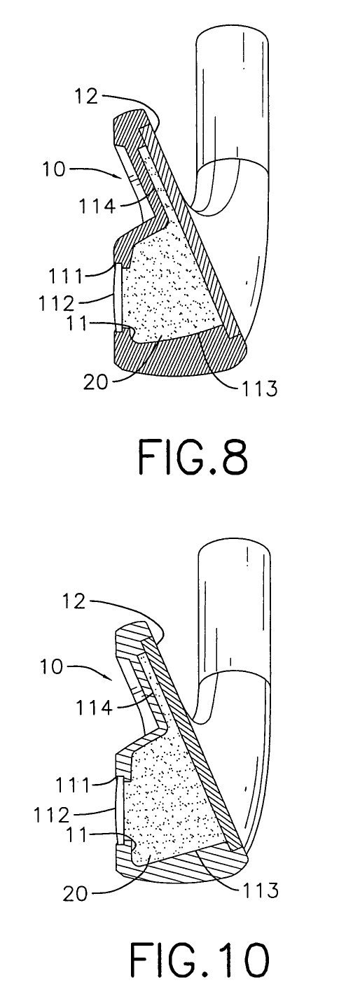

With further reference to FIGS. 3, 4, 6, 8 and 10 the injecting step (b) comprises blocking the window (111) by a stopper (41) first, then mounting a nozzle (131) of an injection molding machine and at least one exhausting element (141) respectively into the through holes (13, 13A, 14, 14A) and injecting vibration-absorbing material (20) into the recess (11) via the nozzle (131) to allow air in the recess (11) to be exhausted via the at least one exhausting element (41). Air may also be exhausted via the at least one exhausting hole (15). The vibration-absorbing material (20) may occupy the first inner space (113) of the recess (11) and may further occupy the second inner space (114) of the recess (11).

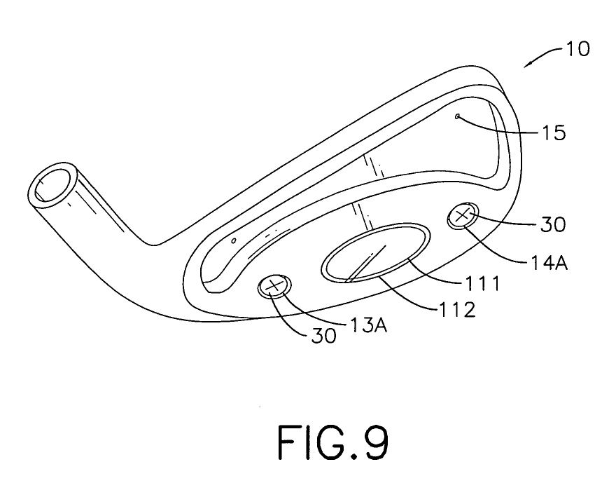

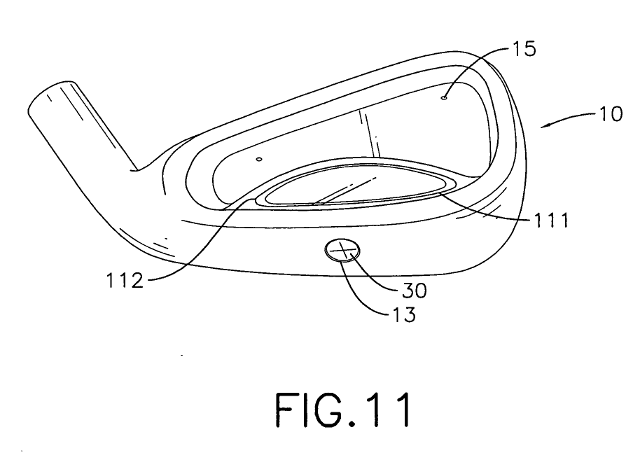

With further reference to FIGS. 9 and 11, the surface finishing step (c) comprises removing the stopper (41), the nozzle (131) and the at least one exhausting element (141) when the vibration-absorbing material (20) is foamed and molded to adhere the recess (11) and then mounting at least one sealing element (30) to block up the at least one through hole (13, 13A, 14, 14A).

The sealing step (d) comprises adhering a transparent panel (112) on the recess (11) to seal the window (111) to obtain a golf club head with vibration-absorbing effect.

Because the window (111) is sealed by the transparent panel (112), users can see the vibration-absorbing material (20) in the recess (11) of the recess (11) from the transparent pane; (112) and determine the vibration-absorbing material (20) is good or not.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A method for producing a golf club head having
a molding step comprising
obtaining a base and a striking faceplate; and
punching a recess, an window, multiple through holes in the base in the base; wherein
the base has
a front surface;
a rear surface;
an upper surface; and
a lower surface; and
the recess is formed in the front surface and has an opening formed in the front surface of the base and receiving the striking faceplate to block up the opening;
the window is defined through the rear surface of the base and communicates with the recess; and
the through holes defined through the base and communicate with the recess;
an injecting step comprising
blocking the window by a stopper;
then mounting a nozzle of an injection molding machine and at least one exhausting element respectively into the through holes; and
injecting vibration-absorbing material into the recess via the nozzle to allow air in the recess to be exhausted via the at least one exhausting element;
a surface finishing step comprising
removing the stopper, the nozzle and the at least one exhausting element when the vibration-absorbing material is foamed and molded to adhere the recess; and
mounting at least one sealing element to block up the at least one through hole; and
a sealing step comprising adhering a transparent panel on the recess to seal the window to obtain a golf club head with vibration-absorbing effect.

2. The method for producing a golf club head as claimed in claim 1, wherein the molding step further comprises punching an exhausting hole through the striking faceplate.

3. The method for producing a golf club head as claimed in claim 1, wherein the through holes are defined through the lower surface of the base.

4. The method for producing a golf club head as claimed in claim 1, wherein the base further has at least one exhausting hole defined through the striking faceplate and allowing the air in the recess to be exhausted via the at least one exhausting hole.

5. The method for producing a golf club head as claimed in claim 1, wherein the through holes are defined through the rear surface of the base.

6. The method for producing a golf club head as claimed in claim 1, wherein the recess further comprising a first inner space and the vibration-absorbing material occupies the first inner space of the recess.

7. The method for producing a golf club head as claimed in claim 6, wherein the recess further comprising a second inner space and the vibration-absorbing material occupies the first inner space and the second inner space of the recess.
